(19) United States
(12) Patent Application Publication
(10) Pub. No.: US 2025/0097363 A1
(43) Pub. Date: Mar. 20, 2025

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KAZUKI KADO, Kanagawa (JP)

(21) Appl. No.: 18/807,864

(22) Filed: Aug. 16, 2024

(30) Foreign Application Priority Data
Sep. 15, 2023 (JP) 2023-150322

(51) Int. Cl. H04N 1/32; H04N 1/00

(52) U.S. Cl. CPC H04N 1/32096; H04N 1/0048

(57) ABSTRACT

An object of the present disclosure is to allow a user to use a sending function for a proper address. An embodiment of the present invention is an information processing apparatus having a sending function to send information to a predetermined address, including: a first display control unit configured to display a first screen to warn about a possibility that a calling number is not a calling number including an external number in a case where beginning of the calling number matches the external number.

### BACKGROUND

### Field

The present disclosure relates to an information processing apparatus, a method of controlling the information processing apparatus, and a storage medium.

### Description of the Related Art

In general, recent multifunction peripherals (hereinafter, described as MFPs) are equipped with a function of scanning a document and sending the document to an arbitrary address, such as faxing and EMAIL transmission.

There has been known Japanese Patent Laid-Open No. 2002-218100 as a technique of calling with an optimal line if a dial number is an external number in a case of using the above-mentioned sending function. In Japanese Patent Laid-Open No. 2002-218100, first, a head character string of the dial number is extracted in fax transmission, and whether the extracted head character string matches a registered external number is determined. If the head character string does not match the registered external number, it is determined as internal transmission, which is G3 transmission. If the head character string matches the registered external number, it is determined as external transmission, which is super G3 transmission.

Additionally, there has been also known an MFP equipped with a function to register an external number in advance, extract a head character string of a dial number in fax transmission, cancel the fax transmission if it is determined that there is no registered external number in the head of the extracted character string, and prompt inputting of the external number.

### SUMMARY

In the conventional technique, it has been determined that there is an external number in a head of a dial number if a character string “00”, which is a combination of a registered external number and the Japanese domestic prefix “0”, matches the beginning of a character string of the dial number. For example, for “012-345-6789”, it is determined that there is no external number in the head, and for “0-012-345-6789”, it is determined that there is the external number in the head.

On the other hand, for example, in Japan, a specific service number that is called a 1XY special number, such as caller number notification (186) or unknown caller (184), is inputted between the external number and the domestic prefix in some cases. Specifically, there may be a number like “0-184-012-345-6789”. Since such a number does not include the character string that begins with “00”, the conventional technique has a problem that it is determined that there is no external number in the head, and the fax transmission cannot be performed.

Under the circumstances, in light of the above-described problem, an object of the present disclosure is to allow a user to use a sending function for a proper address.

An embodiment of the present invention is an information processing apparatus having a sending function to send information to a predetermined address, including: a first display control unit configured to display a first screen to warn about a possibility that a calling number is not a calling number including an external number in a case where beginning of the calling number matches the external number.

Further features of the present invention will become apparent from the following description of exemplary embodiments with reference to the attached drawings.

### BRIEF DESCRIPTION OF THE DRAWINGS

FIG. 1 is a block diagram illustrating a hardware configuration of an MFP;

FIG. 2 is a basic screen to perform a basic operation of a fax;

FIG. 3 is a calling number restriction setting screen;

FIG. 4 is a flowchart of processing to perform calling number restriction;

FIG. 5 is a calling prohibition pop-up screen;

FIG. 6 is a calling warning pop-up screen;

FIG. 7 is a table gathering behaviors of the MFP;

FIG. 8 is a table gathering the behaviors of the MFP;

FIG. 9 is a calling number restriction setting screen; and

FIG. 10 is a table gathering the behaviors of the MFP.

### DESCRIPTION OF THE EMBODIMENTS

Embodiments of the present disclosure are described below with reference to the drawings. Note that, the descriptions below are not intended to limit the invention described in the scope of claims more than necessary. As long as it is possible to achieve a similar effect as an effect of the object of the present disclosure, a part of or all the configurations described below may be replaced with equivalents.

### First Embodiment

### <Hardware Configuration of MFP 100>

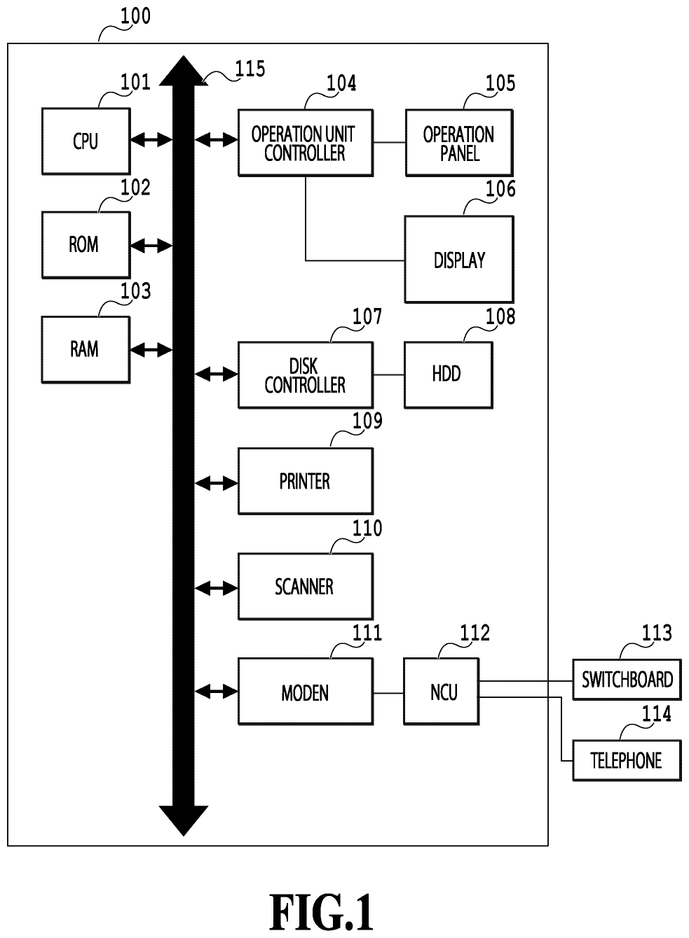

FIG. 1 is a block diagram illustrating a hardware configuration of an MFP 100 as an example of an information processing apparatus of the present disclosure. Note that, although a multifunction peripheral (MFP) is described as an example herein, the present disclosure is also applicable to an information processing apparatus other than the MFP (a PC, a smartphone, a tablet terminal, and so on).

The MFP 100 includes a CPU 101 that executes a software program stored in a ROM 102 or a hard disk drive (HDD) 108. The CPU 101 comprehensively controls devices connected to a system bus 115. Note that, the HDD 108 can be used also as a temporal storage place of an image. Note that, in the present specification, the “image” indicates a collective term of a picture and an imagery that are drawn (to be drawn) or image data expressing the picture and the imagery that are drawn (to be drawn). The image temporarily stored in the HDD 108 is the latter.

ARAM 103 functions as a main memory, a working area, and the like of the CPU 101. An operation unit controller 104 controls various buttons, an operation panel 105, a display 106, and the like included in the MFP 100. A disk controller 107 controls the HDD 108.

A printer 109 is a printing unit that executes printing on a printing medium (for example, a sheet, a film, and so on) by using a printing material. Note that, a printing method may be an electrophotographic method, an ink jet method, or another method.

A scanner 110 is a reading unit that reads information (for example, the image) printed on the printing medium. In general, an automatic document feeder (ADF) is mounted on the scanner 110 optionally, and it is possible to automatically read multiple documents.

A MODEM 111 demodulates a modulation signal received via a switchboard 113 and, on the other hand, modulates a signal from the apparatus and sends the signal to the switchboard 113. The switchboard 113 is a device that connects phone lines to each other and, for example, has a function to connect a phone network that allows for a phone call within an organization (an internal line) to a phone network outside the organization (an external line). An NCU 112 corresponds to an interface portion between the phone line and the fax and performs line control to detect the signal transmitted from the switchboard 113 and transfer the signal to the MODEM 111 and to switch the lines for the fax and a telephone 114.

### <Basic Screen of Fax>

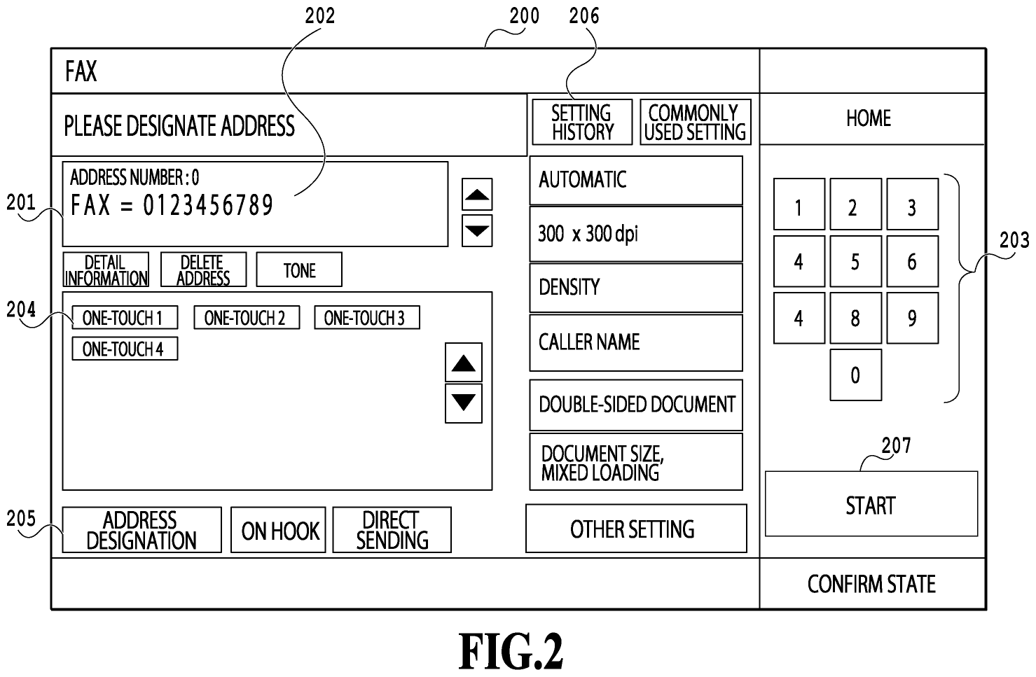

FIG. 2 illustrates a basic screen 200 to perform a basic operation of the fax as a GUI screen of the MFP 100. A calling number 202 inputted by the user is displayed on a calling display area 201. Usually, the calling number 202 is inputted by using a numeric keypad button group 203. Note that, the calling number 202 that is registered in advance may be inputted or set by operating a button such as a one-touch button 204 that calls the calling number 202 registered in advance, an address designation button 205 that calls an address book, and a setting history button 206 that calls the calling history. After setting the calling number 202, the user performs fax transmission by pressing a fax transmission start button 207.

### <Setting of Calling Number Restriction>

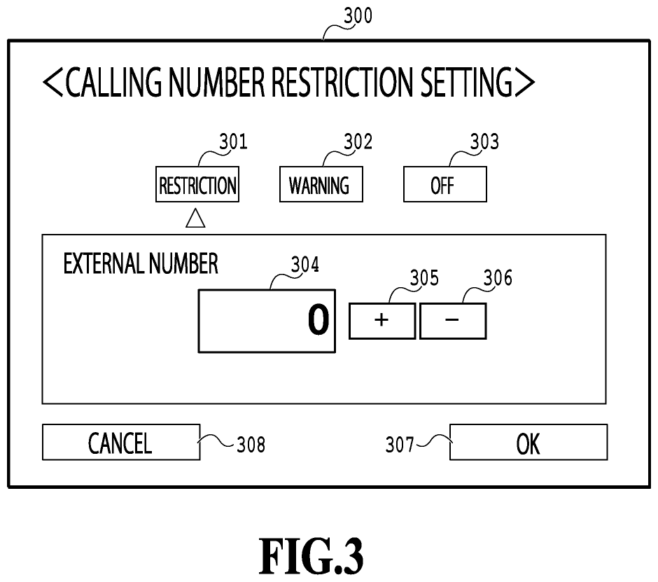

FIG. 3 is a diagram illustrating a calling number restriction setting screen 300 as the GUI screen of the MFP 100. With this screen, the user sets a behavior of the MFP 100 in a case where the calling number 202 is analyzed and it is decided as an external number (details are described later).

The user sets the behavior of the MFP 100 by pressing a calling number restriction button 301, a calling number warning button 302, or a calling number restriction OFF button 303. There are “restriction”, “warning”, and “OFF” as specific settings of the calling number restriction, and the user selects any one of them.

Additionally, in a case where the calling number restriction button 301 or the calling number warning button 302 is pressed and selected, it is possible to set an external number 304 that is desired to be registered with the MFP 100. The external number 304 can be set by pressing a plus button 305 and a minus button 306. Note that, the external number 304 may be inputted by using the numeric keypad button group 203. The set contents are registered with the MFP 100, that is, stored in the ROM 102 or the HDD 108 by pressing an OK button 307. In a case where a cancel button 308 is pressed, it is possible to discard the set contents. The CPU 101 can perform the later-described calling number restriction in the fax transmission by registering a number that is for the external connection by the switchboard 113 with the MFP 100 as the external number 304. Note that, the external number is also called as an external calling number.

### <Specific Processing of Calling Number Restriction>

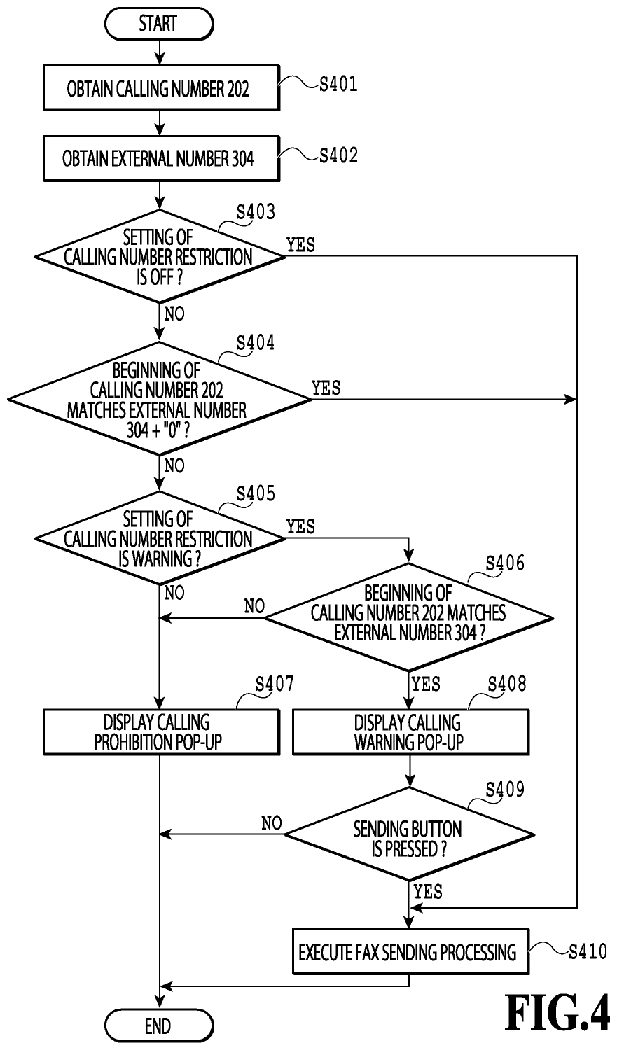

Processing to perform the calling number restriction is described below with reference to FIG. 4. The CPU 101 deploys a program describing the procedure illustrated in FIG. 4 (that is stored in the ROM 102) to the RAM 103 and executes the deployed program. Therefore, the series of processing illustrated in FIG. 4 is executed. Additionally, the processing in FIG. 4 is started with the user setting the calling number 202 and pressing the fax transmission start button 207.

First, in step S401, the CPU 101 obtains the calling number 202 inputted by the user as a character string. Note that, hereinafter, “step S” is abbreviated as “S”.

In S402, the CPU 101 obtains the external number 304 stored in the ROM 102 or the HDD 108 as a character string.

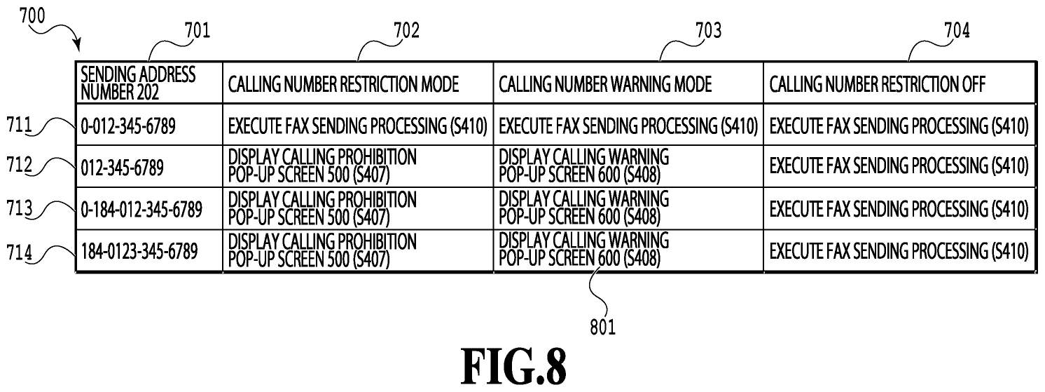

In S403, based on a setting value of the calling number restriction stored in the ROM 102 or the HDD 108, the CPU 101 determines whether the setting of the calling number restriction is OFF (that is, whether it is in a calling number restriction OFF mode state by pressing of the calling number restriction OFF button 303). If a determination result of the present step is true, the process proceeds to S410. On the other hand, if the determination result of the present step is false, the process proceeds to S404. Note that, the calling number restriction OFF mode is one of operation modes of the MFP 100 and is a mode in which the restriction based on the calling number is not performed. The MFP 100 operates in any one of a calling number restriction mode, a calling number warning mode, or the calling number restriction OFF mode, and the details are described later (see FIG. 8).

In S404, the CPU 101 determines whether the beginning of the calling number 202 obtained in S401 matches a character string that is a combination of the external number 304 (obtained in S402) and a fixed value (in the present example, “0”). Note that, the “beginning” indicates a portion of at least one or more characters that starts from the head (one character) of the character string. With the determination of the present step, in a case where a phone number starts with “0”, it is possible to determine whether this phone number is a phone number including the external number 304. For example, in a case where the external number 304 is set to “0”, the calling number 202 “00123456789” is determined as the phone number including the external number 304. On the other hand, the calling number 202 “0123456789” or “123456789” is not determined as the phone number including the external number 304. If a determination result of the present step is true, the process proceeds to S410. On the other hand, if the determination result of the present step is false, the process proceeds to S405.

In S405, based on the setting value of the calling number restriction stored in the ROM 102 or the HDD 108, the CPU 101 determines whether the setting of the calling number restriction is warning (whether it is in a state in which the calling number warning button 302 is pressed). If a determination result of the present step is true, the process proceeds to S406. On the other hand, if the determination result of the present step is false (that is, if the setting of the calling number restriction is restriction), the process proceeds to S407.

In S406, the CPU 101 determines whether the beginning of the calling number 202 obtained in S401 matches the external number 304 (obtained in S402). With the determination of the present step, it is possible to determine whether there is a possibility that this phone number is the phone number including the external number 304 even in a case where the phone number does not start with the domestic prefix “0”. For example, in a case where the external number 304 is “0”, it is possible to determine that there is a possibility that the calling number 202 “0184123456789” is the phone number including the external number 304, and it is possible to determine that there is no possibility that the calling number 202 “184123456789” is the phone number including the external number 304. If a determination result of the present step is true, the process proceeds to S408. On the other hand, if the determination result of the present step is false, the process proceeds to S407.

In S407, the CPU 101 displays a calling prohibition pop-up that notifies the user of that the calling number 202 is not the phone number including the external number 304, and the calling is prohibited. Thus, in the present step, the CPU 101 functions as a display control unit configured to display the calling prohibition pop-up on the display 106, which is a display unit.

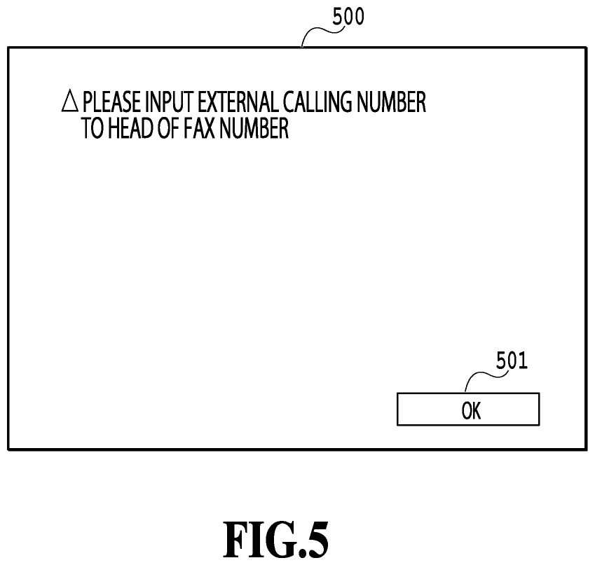

FIG. 5 illustrates a calling prohibition pop-up screen 500 as an example of the calling prohibition pop-up displayed in S407. It is possible to prompt the user to add and input the external number 304 to the head of the fax number by displaying a message notifying of that the fax transmission is not to be performed like “Please input external calling number to head of fax number”. In a case where the user presses the screen through an OK button 501 on the calling prohibition pop-up screen 500, the flow in FIG. 4 ends. Therefore, fax sending processing in S410 is not executed. Accordingly, for example, in a case where the calling number 202 is “0123456789”, it is possible to prevent accidental calling as “123456789” by the switchboard 113.

In S408, the CPU 101 displays a calling warning pop-up to confirm with the user whether to make a call on the display 106. Thus, in the present step, the CPU 101 functions as a display control unit configured to display the calling warning pop-up on the display 106, which is the display unit.

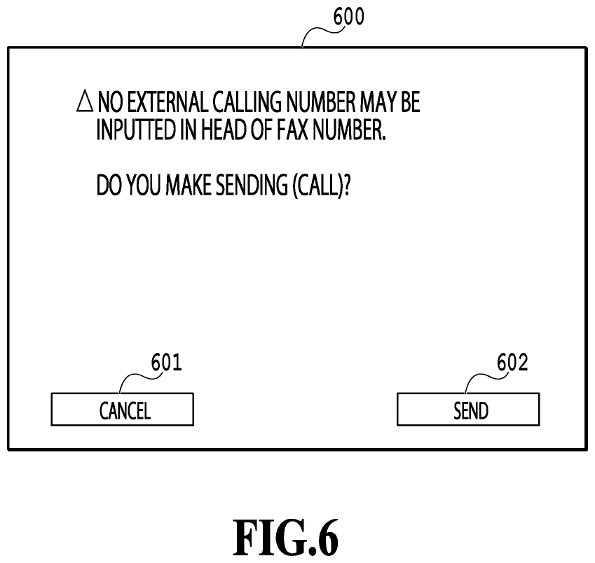

FIG. 6 illustrates a calling warning pop-up screen 600 as an example of the calling warning pop-up displayed in S408. As illustrated in FIG. 6, a message like “No external calling number may be inputted in head of fax number. Do you make sending (call)?”. Thus, it is possible to notify the user of a possibility that the calling number is not the calling number including the external number (that is, a possibility that the calling number 202 does not include the external number 304).

In S409, the CPU 101 determines whether the user presses a sending button 602. If a determination result of the present step is true, the process proceeds to S410. On the other hand, if the determination result of the present step is false (that is, if a calling cancel button 601 is pressed), it is determined that no fax transmission is to be performed, and the series of processing ends.

In S410, the CPU 101 executes the fax sending processing, and the series of processing ends.

According to the above-described processing, in a case where the calling number 202 is a combination of the external number 304, the 1XY special number, and the phone number that starts with the domestic prefix “0”, it is possible to perform the fax transmission with a warning of the possibility that no external number 304 is included. The calling number 202 in this case is “01840123456789”, for example. This number is a combination of the external number 304 (0), the 1XY special number (184), and the phone number that starts with the domestic prefix “0” (0123 . . . ).

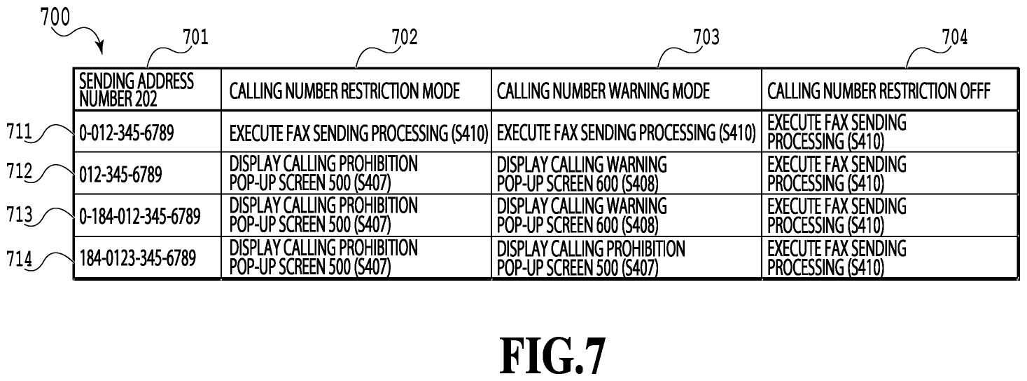

The behaviors of the MFP 100 for the calling number 202 according to the setting contents of the calling number restriction setting screen 300 that are implemented in the flowchart illustrated in FIG. 4 are illustrated in a table 700 in FIG. 7. A column 701 indicates an example of the calling number 202. Note that, although a hyphen is inserted in the character string in view of easy understanding of the table, the hyphen is not treated as the character string of the calling number 202. Additionally, it is assumed that “0” is set as the external number 304. Moreover, the MFP 100 operates in any one of the calling number restriction mode, the calling number warning mode, or the calling number restriction OFF mode.

A calling number restriction mode column 702 indicates a behavior in a case where the setting of the calling number restriction is restriction, that is, in a case where the calling number restriction button 301 is pressed on the calling number restriction setting screen 300. In the calling number restriction mode column 702, if the calling number 202 starts with “0” “0”, in S410, the fax sending processing is executed (a row 711). On the other hand, if the calling number 202 does not start with “0” “0”, in S407, the calling prohibition pop-up screen 500 is displayed, and no fax sending processing (S410) is executed (a row 712, a row 713, and a row 714).

A calling number warning mode column 703 indicates a behavior in a case where the setting of the calling number restriction is warning, that is, the calling number warning button 302 is pressed on the calling number restriction setting screen 300. In the calling number warning mode column 703, if the calling number 202 starts with “0” “0”, in S410, the fax sending processing is executed (the row 711). If the calling number 202 does not start with “0” “0” but starts with “0”, in S408, the calling warning pop-up screen 600 is displayed, and in S409, the user can select whether to execute the fax sending processing (the row 712, the row 713). If the calling number 202 does not start with “0”, in S407, the calling prohibition pop-up screen 500 is displayed, and no fax sending processing (S410) is executed (the row 714).

A calling number restriction OFF mode column 704 indicates a behavior in a case where the setting of the calling number restriction is OFF, that is, the calling number restriction OFF button 303 is pressed on the calling number restriction setting screen 300. In the calling number restriction OFF mode column 704, the fax sending processing (S410) is executed regardless of the calling number 202 (the row 711, the row 712, the row 713, and the row 714).

With the above-described configuration, it is possible to perform the fax sending to the intended address with no fail while preventing forgetting to add the external number and accidental calling with the calling number to which adding of the external number is forgotten.

As a supplement, the rule and the culture applied to the phone number are different depending on countries and areas. For example, as for the external number, “0” is often set to the switchboard in Japan and Europe while “9” is often set to the switchboard in North America. Additionally, the head of the phone number is called the domestic prefix (Trunk Prefix) or the like, which is treated differently depending on countries and areas. For example, the domestic prefix in Japan, Egypt, Argentina, and the like is “0”. In addition, the domestic prefix in Hungary is “8”, and there are also countries and areas having no fixed domestic prefix. Moreover, the domestic prefix may be expanded for each area like an area code in Japan. For example, in a case of Tokyo, “03” is applied to the head (beginning) of the phone number.

### <First Modification (Calling Warning Pop-Up Screen is Displayed Invariably)>

A variation of the first embodiment is described below.

The calling warning pop-up screen 600 may be displayed invariably in a case where the setting of the calling number restriction is warning, that is, in a case where the calling number warning button 302 is pressed on the calling number restriction setting screen 300. In other words, the step of determining whether there is the possibility that it is the phone number including the external number 304 in the flowchart in FIG. 4 (S406) may not be performed. In this mode, if it is YES in S405, the process proceeds to S408 without S406.

The behaviors of the MFP 100 in a case where S406 in FIG. 4 is not executed are illustrated in the table 700 in FIG. 8. As illustrated in a cell 801, it is different from the above-mentioned first embodiment (see FIG. 7) in that the calling warning pop-up screen 600 is displayed even in a case where the calling number 202 does not start with “0” (the row 714) in the calling number warning mode column 703. With this configuration, in S409, the user can select whether to execute the fax sending processing (S410).

In the warning mode in a first modification, the calling warning pop-up screen 600 is displayed except a case where the beginning of the calling number 202 is a character string that is a combination of the external number 304 (in the present example, “0”) and “0”. Thus, it is possible to reduce a risk of accidental calling.

### <Second Modification (Domestic Prefix is Set)>

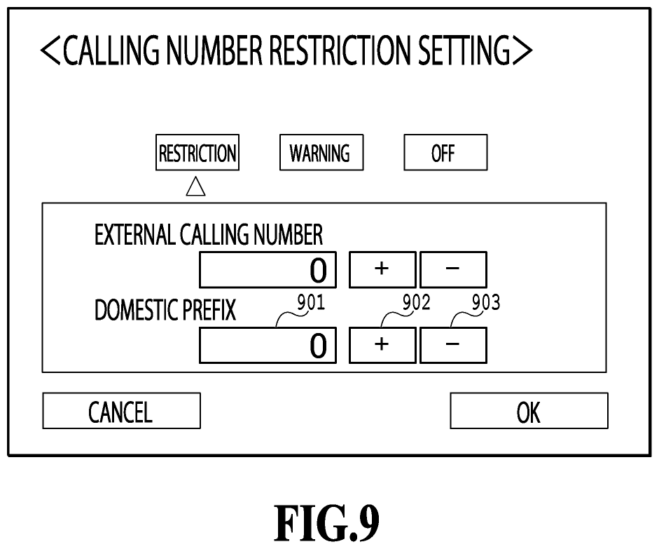

In S404 in FIG. 4, whether the beginning of the calling number 202 is a character string that is a combination of the external number 304 and “0” may not be determined, but whether the beginning of the calling number 202 is a character string that is a combination of the external number 304 and an arbitrary character string may be determined. For example, with the calling number restriction setting screen 300 illustrated in FIG. 9, a domestic prefix 901 may be allowed to be set to an arbitrary value. The domestic prefix 901 can be set by pressing a plus button 902 and a minus button 903. Note that, the domestic prefix 901 may be inputted by using the numeric keypad button group 203.

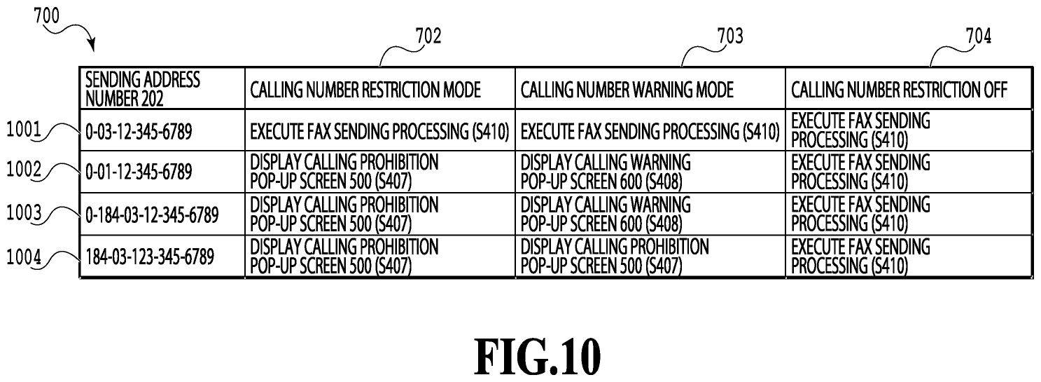

The behaviors of the MFP 100 in a case where whether the beginning of the calling number 202 is a character string that is a combination of the external number 304 and the domestic prefix 901 is determined in S404 are illustrated in the table 700 in FIG. 10. Note that, in the present example, it is assumed that the external number 304 is set to “0”, and the domestic prefix 901 is set to “03”.

As illustrated in the calling number restriction mode column 702, in a case where the calling number 202 starts with “0” and “03”, in S410, the fax sending processing is executed (a row 1001). On the other hand, in a case where the calling number 202 does not start with “0” and “03”, the calling prohibition pop-up screen 500 is displayed, and no fax sending processing (S410) is executed (a row 1002, a row 1003, and a row 1004).

As illustrated in the calling number warning mode column 703, in a case where the calling number 202 starts with “0” and “03”, in S410, the fax sending processing is executed (the row 1001). In a case where the calling number 202 does not start with “0” and “03” but starts with “0”, the calling warning pop-up screen 600 is displayed, and in S409, the user can select whether to execute the fax sending processing (S410) (the row 1002 and the row 1003). In a case where the calling number 202 does not start with “0”, the calling prohibition pop-up screen 500 is displayed, and no fax sending processing (S410) is executed (the row 1004).

In a case where the setting of the calling number restriction is OFF, as illustrated in the calling number restriction OFF mode column 704, the fax sending processing (S410) is executed regardless of the calling number 202 (the row 1001, the row 1002, the row 1003, and the row 1004).

According to the present modification, it is possible to determine whether it is the phone number including the external number 304 according to countries and areas, and it is possible to reduce the risk of accidental calling.

### <Third Modification (No Warning Pop-Up is Displayed)>

The calling warning pop-up screen 600 may not be displayed depending on the number of times the calling cancel button 601 is pressed or the number of times the sending button 602 is pressed on the calling warning pop-up screen 600. For example, in a case where the number of times the user presses the calling cancel button 601 reaches a predetermined threshold, the CPU 101 sets a setting value of the calling number restriction stored in the ROM 102 or the HDD 108 to a value indicating “restriction”. As a result, the MFP 100 transitions to the calling number restriction mode. Accordingly, in a case where the flow illustrated in FIG. 4 is executed next time, since the setting of the calling number restriction is restriction, the calling warning pop-up screen 600 is not displayed but the calling prohibition pop-up screen 500 is displayed, and no fax sending processing (S410) is executed.

Additionally, in a case where the number of times the user presses the sending button 602 reaches the predetermined threshold, the CPU 101 sets the setting value of the calling number restriction stored in the ROM 102 or the HDD 108 to a value indicating “OFF”. As a result, the MFP 100 transitions to the calling number restriction OFF mode. Accordingly, in a case where the flow illustrated in FIG. 4 is executed next time, since the setting of the calling number restriction is OFF, no calling warning pop-up screen 600 is displayed, and the fax sending processing (S410) is executed invariably.

The CPU 101 stores the number of times the calling cancel button 601 is pressed and the number of times the sending button 602 is pressed in the ROM 102 or the HDD 108. Additionally, it is possible to store the predetermined threshold used for the determination on whether to hide the calling warning pop-up screen 600 in the ROM 102 or the HDD 108. This threshold may be arbitrarily set by the user.

According to the present modification, it is possible to reduce the risk of accidental calling by displaying the calling warning pop-up screen 600 and also to improve the usability of the MFP 100 by storing an operation that is performed a certain number of times.

### Other Embodiments

Note that, although a mode of sending data to a proper address is described using the fax function as an example in the above-mentioned embodiment, it is not limited to the fax function. For example, the processing in the above-mentioned embodiment may be applied in a case of sending data on which scanning by the scanner 110 is executed (scanned data) to an address indicating an external apparatus and the like. Therefore, the MFP 100 in the above-mentioned embodiment may at least have a function to send predetermined information to a predetermined address.

The above-mentioned embodiment is implemented also by executing the following processing. In other words, it is processing in which software (a program) implementing the function of the above-mentioned embodiment is supplied to a system or an apparatus via a network or various storage mediums, and the system or a computer of the apparatus (a CPU, an MPU, or the like) reads out and executes the program. Additionally, the program may be executed by a single computer or may be executed by multiple computers in conjunction with each other. Moreover, it is unnecessary to implement all the types of processing described above with the software, and a part of or all the types of processing may be implemented by hardware such as an ASIC. Furthermore, the CPU is not limited to a single CPU that performs all the types of processing, and multiple CPUs may perform the processing in cooperation with each other as needed.

Additionally, the function of the above-mentioned example is implemented not only with the computer executing a program code read out. There is also included a case where an OS or the like operating on the computer performs a part of or all the types of actual processing based on an instruction of the corresponding program code, and the function of the above-mentioned embodiment is implemented by the processing.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to allow a user to use a sending function for a proper address.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-150322, filed Sep. 15, 2023, which is hereby incorporated by reference wherein in its entirety.

What is claimed is:

1. An information processing apparatus having a sending function to send information to a predetermined address, comprising:
a first display control unit configured to display a first screen to warn about a possibility that a calling number is not a calling number including an external number in a case where beginning of the calling number matches the external number.

2. The information processing apparatus according to claim 1, further comprising:
a first obtainment unit configured to obtain the calling number as a character string; and
a second obtainment unit configured to obtain the external number set by a user as a character string.

3. The information processing apparatus according to claim 2, further comprising:
a first determination unit configured to determine whether the beginning matches a character string that is a combination of the external number and a fixed value;
an execution unit configured to execute fax sending processing in a case where a determination result of the first determination unit is true; and
a second determination unit configured to determine whether it is a warning mode in which the first screen is displayed in a case where a determination result of the first determination unit is false.

4. The information processing apparatus according to claim 3, wherein
the fixed value is 0.

5. The information processing apparatus according to claim 3, wherein
the fixed value is a domestic prefix.

6. The information processing apparatus according to claim 5, wherein
the domestic prefix can be set to an arbitrary value by the user.

7. The information processing apparatus according to claim 4, wherein
in a case where a determination result of the second determination unit is true, the determination by the first determination unit is executed.

8. The information processing apparatus according to claim 7, wherein
in a case where a determination result of the first determination unit is true, the first display control unit displays the first screen.

9. The information processing apparatus according to claim 4, wherein
in a case where a determination result of the second determination unit is true, the first display control unit displays the first screen.

10. The information processing apparatus according to claim 8, wherein
the first screen includes a first button to execute fax sending and a second button to cancel the fax sending.

11. The information processing apparatus according to claim 10, wherein
in a case where the first button is pressed, the execution unit executes the fax sending processing, and
in a case where the second button is pressed, the execution unit does not execute the fax sending processing.

12. The information processing apparatus according to claim 11, further comprising:
a second display control unit configured to display a second screen to notify of that no fax transmission is performed in a case where a determination result of the first determination unit is false.

13. The information processing apparatus according to claim 12, wherein
the information processing apparatus operates in any one of operation modes, which are a restriction mode in which the second screen is displayed as a restriction using the calling number, the warning mode, and an OFF mode in which the restriction using the calling number is not performed.

14. The information processing apparatus according to claim 13, wherein
in a case where the number of times the second button is pressed reaches a predetermined threshold, the operation mode transitions to the restriction mode.

15. The information processing apparatus according to claim 13, wherein
in a case where the number of times the first button is pressed reaches a predetermined threshold, the operation mode transitions to the OFF mode.

16. The information processing apparatus according to claim 1, wherein
the sending function is a fax function.

17. The information processing apparatus according to claim 1, wherein
the sending function is a function to send data on which scanning is executed to the predetermined address.

18. A method of controlling an information processing apparatus having a sending function to send information to a predetermined address, comprising:
displaying a first screen to warn about a possibility that a calling number is not a calling number including an external number in a case where beginning of the calling number matches the external number.

19. A non-transitory computer readable storage medium storing a program causing a computer to execute a method of controlling an information processing apparatus having a sending function to send information to a predetermined address, comprising:
displaying a first screen to warn about a possibility that a calling number is not a calling number including an external number in a case where beginning of the calling number matches the external number.
